(19) United States
(12) Patent Application Publication
(10) Pub. No.: US 2003/0060270 A1
(43) Pub. Date: Mar. 27, 2003

(54) Articulating gaming terminals, systems including such terminals, and methods

(76) Inventors: Wesley A. Binkley, Bozeman, MT (US); David C. Vance, Vacence, WA (US); Lee E. Cannon, Bozeman, MT (US)

Correspondence Address: Marshall Gerstein & Borun, 6300 Sears Tower, 233 South Sacker Drive, Chicago, IL, 60606-6402, US

(21) Appl. No.: 09/966,763

(22) Filed: Sep. 27, 2001

(51) Int. Cl. A63F 13/00

(52) U.S. Cl. 463/20

(57) ABSTRACT

A gaming terminal includes at least one articulating element. The articulating element may be a monitor that may be moved along one or more axes, either automatically or by a gamer. A flat panel display may be used as the monitor of such a gaming terminal to facilitate articulation thereof. Due to the use of a flat panel display, the gaming terminal may be relatively compact when compared with conventional gaming terminals. Further compactness of the gaming terminal may be achieved by omitting elements for receiving, retaining, and dispensing currency. The gaming terminal may be part of a gaming network, which may also include on or more of a network server and an automated cashier. Methods for adjusting an articulating element of the gaming terminal are disclosed, as are methods for using a cashless gaming system.

### BACKGROUND OF THE INVENTION

1. Field of the Invention

The present invention relates generally to gaming terminals and, more specifically, to compact gaming terminals with adjustable components. The present invention also relates to gaming terminals that do not require the input of cash or provide cash awards. In addition, the present invention relates to systems that include a pluralities of gaming terminals.

2. Background of Related Art

Gaming terminals of various types have been developed to allow gamers to gamble on their own, without the requirement of dealers or other casino personnel. Individual gaming terminals may also be installed into other, non-casino establishments.

Typically, conventional gaming terminals are somewhat bulky, uprightly oriented devices. Conventional gaming terminals typically include user-interfacing apparatus, such as the slot and reels of a slot machine or the monitor and buttons of a video poker or black jack machine, that are positioned so as to face and, thus, facilitate use by a gamer standing in front of a gaming terminal, or sitting in a somewhat elevated position in front of the gaming terminal. In addition, conventional gaming terminals include apparatus for accepting currency, credit and debit cards, and/or cards for prepaid accounts, as well as equipment for providing gamers with monetary rewards upon achieving certain, predetermined results during game play. Typically, each of these elements, along with any other elements of conventional gaming terminals remain in substantially fixed positions. Thus, in order to view the input and output portions of the gaming terminal in a desired manner, a gamer must accordingly adjust his or her position, which may be uncomfortable, especially during prolonged periods of game play.

Another, more compact type of gaming terminal includes user-interfacing apparatus that are oriented to face in a generally upward (including somewhat angled) direction. This type of gaming terminal may be used by a gamer while sitting in a chair of standard height, or installed into a bar top, as described in U.S. Pat. No. 5,655,966, issued to Werdin, Jr. et al. on Aug. 12, 1997. Again, however, such the user-interfacing apparatus of such gaming terminals typically remain in fixed positions, requiring a gamer to adjust his or her position to view the user-interfacing apparatus as desired.

Adjustable chairs have been developed for use at various types of gaming terminals and gaming tables in attempts to increase a gamer's comfort while playing a game. While adjustable chairs provide support to gamers during use, they often only support the gamers in positions that, due to the inflexibility of user-interfacing apparatus of conventional gaming terminals, become uncomfortable when retained for long periods of time.

The inventors are not aware of a gaming terminal that includes components that articulate or that may otherwise be adjusted to permit a gamer to play a game while sitting in a comfortable position.

### SUMMARY OF THE INVENTION

The present invention includes a gaming terminal that includes one or more articulating, or positionable, components. The one or more articulating components of the gaming terminal may be positioned to tailor the gaming terminal to a number of different configurations suitable for gamers of different body shapes and sizes. Adjustment of one or more components of the gaming terminal of the present invention to a plurality of positions may, for example, increase the comfort of a gamer during use of the gaming terminal, facilitate a gamer's accessibility to one or more components of the gaming terminal, or the like.

Among other things, the gaming terminal of the present invention includes a processor, as well as a monitor and at least one user input element associated with the processor. The processor, monitor, and at least one user input element may be housed within a single compact cabinet or within separate housings, any of which may articulate relative to any of the other components of the gaming terminal. By way of example only, in order to facilitate adjustment of the position of a monitor of the gaming terminal, a so-called “flat panel” monitor may be used. Such a monitor may be hingedly or otherwise adjustably secured to or within a main body of the gaming terminal. Other components of the gaming terminal may likewise have reduced sizes relative to corresponding components in conventional gaming terminals.

The gaming terminal of the present invention may also lack apparatus for receiving currency and for providing awards of currency. Accordingly, such a gaming terminal may be referred to as a “cashless” gaming terminal.

The present invention also includes systems including groups of compact gaming terminals. Such systems may additionally include automated cashiers, into which a gamer may introduce currency, tokens, credit or debit cards, or other types of account access cards to obtain game credits. Game credits may similarly be obtained from such an automated cashier.

A gaming method incorporating teachings of the present invention may include obtaining a number of game credits and receiving a house account to facilitate access to the game credits. The house account may subsequently be accessed from a cashless gaming terminal to facilitate use of the cashless gaming terminal. When new games are played at such a cashless gaming terminal, credits are deducted from the account. When a gamer wins a game, the cashless gaming terminal may award credit to the account. Upon completion of gaming, a gamer may redeem the credits remaining in the account, receiving the monetary value of the credits or another type of award.

Other features and advantages of the present invention will become apparent to those of ordinary skill in the art through consideration of the ensuing description, the accompanying drawings, and the appended claims.

### BRIEF DESCRIPTION OF THE DRAWINGS

In the drawings, which depict various aspects of exemplary embodiments of the present invention:

FIG. 1 is a frontal perspective view of an exemplary embodiment of gaming terminal incorporating teachings of the present invention, which includes an articulating monitor;

FIG. 2 is a side view of the gaming terminal shown in FIG. 1;

FIG. 3 is a frontal perspective view of another exemplary embodiment of gaming terminal according to the invention;

FIG. 4 is a side view of the gaming terminal of FIG. 3;

FIG. 5 is a frontal view of yet another exemplary embodiment of gaming terminal incorporating teachings of the present invention;

FIG. 6 is a size view of the gaming terminal shown in FIG. 5;

FIG. 7 is a schematic representation of a gaming network including a gaming terminal according to the present invention; and

FIG. 8 is a frontal perspective view that schematically depicts an automated cashier that may be used in a gaming network, such as that depicted in FIG. 7.

### DETAILED DESCRIPTION OF THE INVENTION

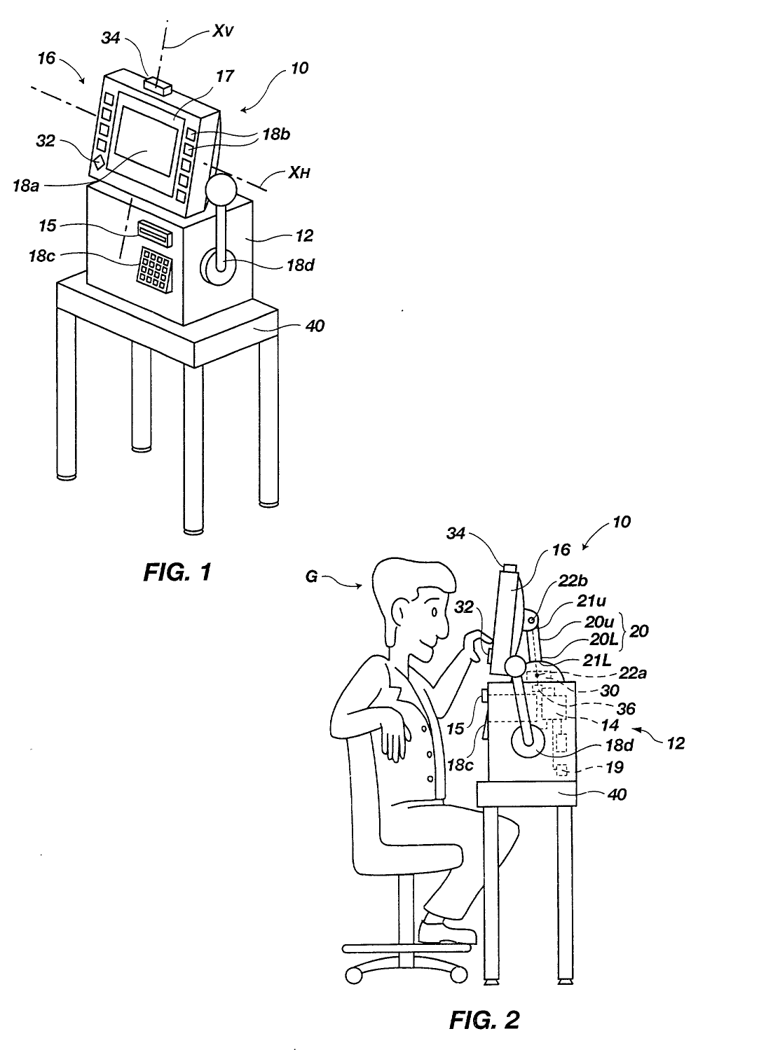

With reference to FIGS. 1 and 2, an exemplary embodiment of a gaming terminal 10 according to the present invention is illustrated. Gaming terminal 10 includes, among other things, a base 12, a processor 14 for controlling the operation of gaming terminal 10, a monitor 16 for displaying a game or other information, and one or more user input elements 18, such as touch-sensitive regions 18a of monitor 16, buttons 18b, an alphabetic and/or numeric keypad 18c, and/or an actuation arm 18d, such as that typically associated with a so-called “slot” or “reel” machine. Monitor 16 and each user input element 18 of gaming terminal 10 are in communication with processor 14 thereof. In addition, gaming terminal 10 may include a card reader 15 of known configuration to facilitate the use of account cards (e.g., credit cards, debit cards, house account cards, etc.) to initiate game play at gaming terminal 10.

As depicted, one or more of the elements of gaming terminal 10 articulate relative to base 12 thereof.

As one example of an articulating element of gaming terminal 10, monitor 16 may move along at least one axis and, preferably, in a plurality of different axes. As depicted, monitor 16 may be moved horizontally toward and away from a gamer G (i.e., fore and aft), vertically (i.e., up and down), and tilted about a horizontal axis X_{H} that extends along or behind a viewing screen 17 thereof. The ability to move monitor 16 into a desired position may increase a gamer's physical comfort when using gaming terminal 10, which may significantly increase the duration of time a gamer will remain at that gaming terminal 10, as well as increase the gamer's level of enjoyment while using gaming terminal 10.

Monitor 16 may comprise a so-called “flat panel display”, such as a light emitting diode (LED) type monitor, a thin-profile cathode ray tube (CRT) monitor, a liquid crystal display (LCD) type monitor, a plasma monitor, or a field emission display (FED). Such flat panel displays are typically much smaller and, thus, weigh much less than conventional CRT monitors with comparable screen sizes. Due to their reduced size and weight, flat panel displays are more amenable than conventional CRT monitors to use in applications where monitor articulation is desired.

An exemplary manner by which such articulation of monitor 16 may be effected includes the use of one or more of moveable support members 20, which are also referred to herein as an “articulation system”, to secure monitor to base 12. As depicted, gaming terminal 10 includes a single support member 20 that pivotally connects to both base 12 and monitor 16. Support member 20 includes a lower arm 20L and an upper arm 20U that move in telescopic arrangement with respect to one another. A lower end 21L of lower arm 20L of support member 20 is hingedly secured to base 12 at pivot point 22a, while an upper end 21U of upper arm 20U of support member 20 may be hingedly or pivotally (e.g., with a ball-and-socket type joint) secured to monitor 16 at pivot point 22b.

Movement of monitor 16 may be effected in at least four different axes. For example, fore and aft movement of monitor may be effected by pivotal movement of lower arm 20L relative to base 12, as well as by pivotal movement of monitor 16 relative to upper arm 20U. Vertical movement of monitor may be effected by extending or contracting upper arm 20U and lower arm 20L of support member 20. In addition, monitor 16 may be pivoted along one or both of horizontal axis X_{H} and a vertical axis X_{V} extending through or behind screen 17 of monitor 16 by tilting monitor 16 relative to the position of upper arm 20U of support member 20.

The ease with which movement may occur at each hinged connection, or at pivot points 22a and 22b, and between upper arm 20U and lower arm 20L of support member 20 may be limited by known means. In one example, hinged movement at pivot points 22a and 22b and telescopic movement of upper arm 20U and lower arm 20L relative to one another may be limited by way of ratcheting mechanisms located at or associated with each point of movement. As another example, hingedly interconnected members may mutually engage one another or an intermediate structure with sufficient friction to prevent undesired movement of monitor 16, while allowing monitor 16 to be moved when at least a threshold amount of force is applied to each pivot point 22a, 22b or upon reduction or removal of the friction from one or more of pivot points 22a, 22b. In yet another example, force-limited springs may be used at each pivot point 22a, 22b and secured in stationary position relative to upper and lower arms 20U, 20L. Such springs may be tensioned so as to counteract the gravitational forces acting on monitor 16 and, optionally, small amounts of other types of force that may be applied to monitor 16, such as the force that may be applied to monitor 16 as a gamer touches a touch-sensitive portion 18a of screen 17 thereof or pushes a button 18b or keypad 18c associated with monitor 16 to input information into processor 14 that is relevant to initiating a game or to game play. Still another example of limiting hinge movement includes securing counteracting springs or sets of springs between pivot points 22a and 22b and between upper member 20U and lower member 20L of support member 20 in a fashion that is well within the skill of one in the art. The amount of tension or force applied by such counteracting springs or sets of springs is preferably balanced to as to retain each support member 20 and, thus, a monitor 16 that has been secured to support member 20 in a desired position. One or more hydraulic pistons may be employed in a similar fashion to hold support member 20 in a desired position and, thus, monitor 16 in a desired orientation.

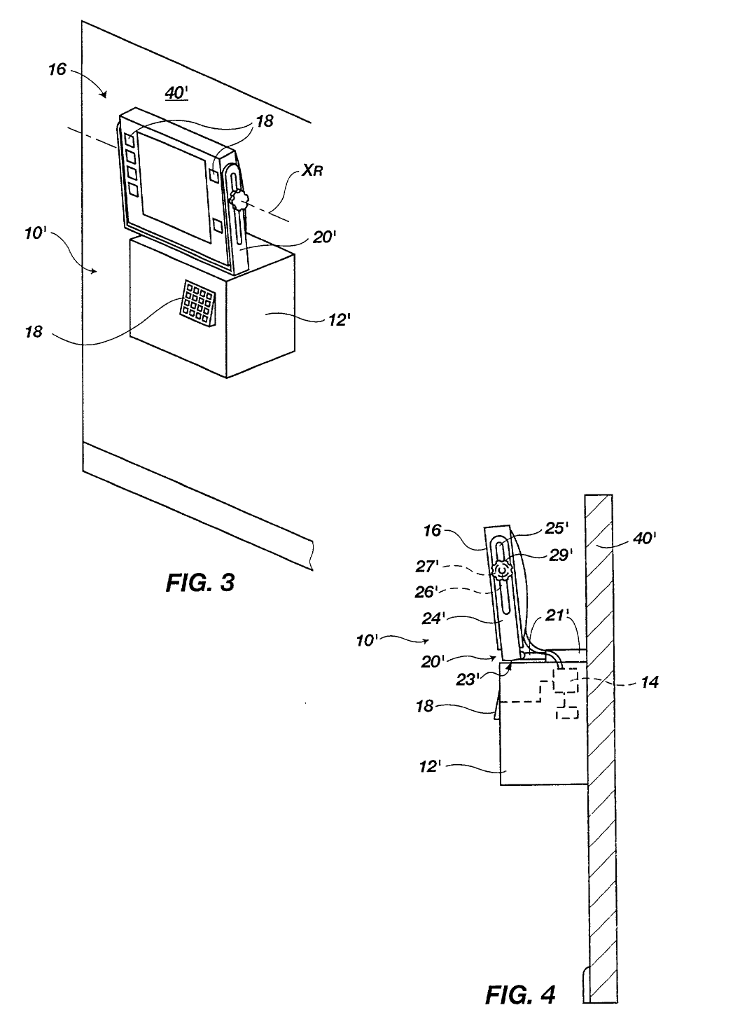

Turning now to FIGS. 3 and 4, another exemplary embodiment of gaming terminal 10′ that incorporates teachings of the present invention is illustrated. Gaming terminal 10′ includes a base 12′ and a monitor 16, as well as a processor 14 and one or more input elements 18. Monitor 16 and each user input element 18 of gaming terminal 10′ are in communication with processor 14 thereof.

Gaming terminal 10′ also includes an articulation system 20′, which is also referred to herein as a support member or, more simply, as a support, that secures monitor 16 to base 12′ in such a manner as to facilitate movement of monitor 16 to a plurality of different positions. While FIGS. 3 and 4 depict an articulation system 20′ that facilitates movement of monitor 16 along at least three different axes, gaming terminals incorporating teachings of the present invention may alternatively include articulation systems that move monitors secured thereto along a lesser or greater number of axes.

As depicted, articulation system 20′ includes at least one support member 21′ that extends from base 12′ toward monitor 16′. Support member 21′ comprises a telescoping member or another element that will facilitate horizontal movement of monitor 16 in fore and aft directions relative to base 12′. An end of support member 21′ located proximate to monitor 16 may be secured either directly to monitor 16 or indirectly thereto by way of a brace 23′.

As shown, brace 23′ includes a pair of rails 24′ having generally C-shaped cross-sections taken transverse to the lengths thereof. Rails 24′ are positioned adjacent to opposite sides of monitor 16. Each rail 24′ includes an elongate slot 25′ extending centrally along the length thereof. Support pins 26′, which protrude from each side of monitor 16, are configured to extend through a slot 25′ of a rail 24′ located on the same side of monitor 16. In addition, each support pin 26′ includes a support ring 27′ thereon that is configured to be inserted into rail 24′ and secured between the opposed, curved flanges thereof. Brace 23′ may also include securement elements, such as the illustrated knobs 29′. Each knob 29′ includes a threaded aperture extending at least partially therethrough and, thus, may be screwed onto complementary threading of a support pin 26′. Upon securing a knob 29′ to a support pin 26′ and against a surface of rail 24′ through which support pin 26′ extends, knob 29′ and support ring 27′ are biased against opposed surfaces of rail 24′ in such a manner as to secure support pin 26′ and, thus, monitor 16 at a particular position along the length of rail 24′. As rails 24′ and slots 25′ thereof are shown as extending generally vertically, each knob 29′—support pin 26′—support ring 27′ assembly facilitates generally vertical movement of monitor 16 relative to brace 23′.

In addition, as the depicted gaming terminal 10′ includes a monitor 16 with a single support pin 26′ protruding from each side thereof, monitor 16 may be rotated about an axis X_{R} extending through both support pins 26′ of monitor 16 and secured in a desired position as each knob 29′—support pin 26′—support ring 27′ assembly is tightened.

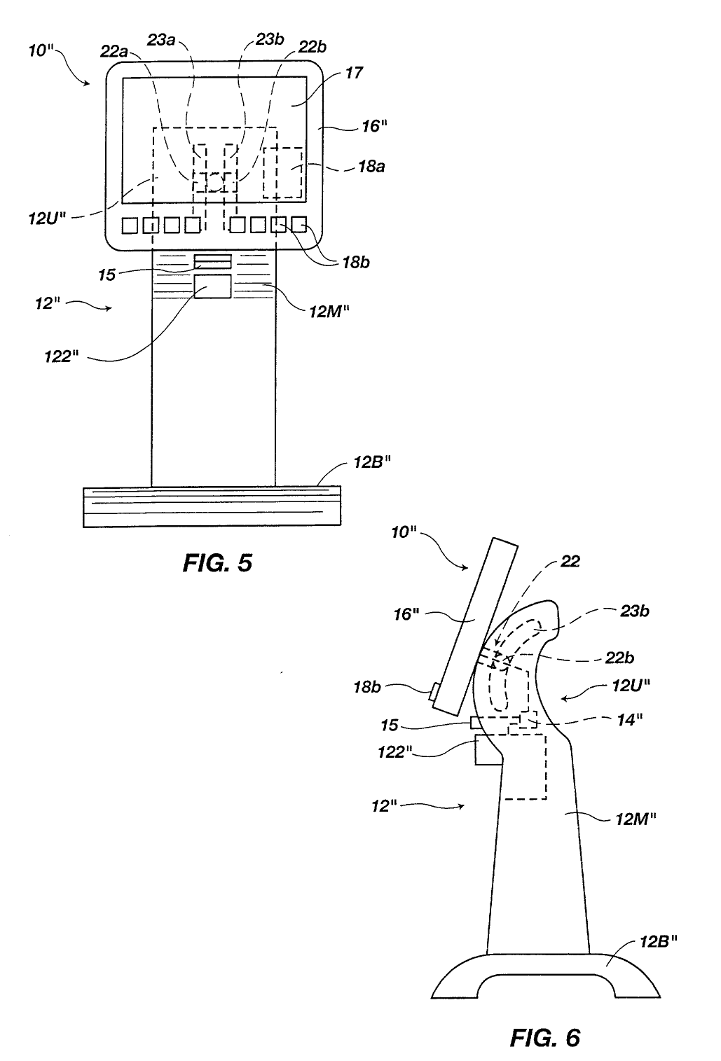

Turning now to FIGS. 5 and 6, another exemplary embodiment of gaming terminal 10″ according to the present invention is depicted. Gaming terminal 10″ includes a base 12″ and a monitor 16″ secured to base 12″ in articulating association therewith. In addition, gaming terminal 10″ includes a processor 14, a card reader 15, and one or more user input elements 18. Gaming terminal 10″ may optionally include payment apparatus 122 ″ for receiving, storing, and dispensing currency (i.e., bills and/or coins), as known in the art.

The shape of base 12″ maybe designed to provide a desired aesthetic appearance, while maintaining the functionality of providing support for gaming terminal 10″ and the various components thereof. By way of example only, base 12″ of gaming terminal 10″ may be shaped to support monitor 16″ in a desired position, as well as to facilitate the articulation of monitor 16″. An upper portion 12U″ of base 12″ may include a monitor support surface 21″ with an arcuate curvature. A middle portion 12M″ of base 12″, which is located beneath monitor 16″, may include card reader 15 and/or payment apparatus 122″ and may protrude somewhat toward the location at which a gamer would position himself or herself upon use of gaming terminal 10″ in order to facilitate the gamer's access to card reader 15 and/or payment apparatus 122″. A lower portion 12L″ of base 12″ may be configured to stabilize and support the remainder of gaming terminal 10″, regardless of the position of monitor 16″.

Although a single processor 14 is depicted as being located within body 12′, gaming terminal 10″ may include a plurality of different processing devices. Alternatively, processor 14 maybe housed within monitor 16″. Processor 14 controls the operation of various electronic components of gaming terminal 10′ and causes monitor 16″ to display a game or other information, as known in the art.

Card reader 15, which communicates with processor 14, may also be of known configuration and associated with processor 14, as known in the art. Card reader 15 facilitates the use of account cards (e.g., credit cards, debit cards, house account cards, etc.), including so-called “smart cards” at gaming terminal 10″.

FIGS. 5 and 6 depict monitor 16′, which rests upon monitor support surface 21″ of upper portion 12U″ of base 12″, as including a support arm 22″ protruding rearwardly therefrom. Support arm 22″ includes opposed, laterally protruding members 22a″ and 22b″ which are configured to be received within corresponding, opposed, elongated, arcuate recesses 23a″ and 23b″ formed in upper portion 12U″ of base 12″. Laterally protruding members 22a″ and 22b″ may be moved along the lengths of their respective recesses 23a″ and 23b″ to move monitor 16″ into a desired position relative to base 12″ and a gamer during his or her use of gaming terminal 10″. Support arm 22″ may include a hollow interior to receive wires, cables, or other elements that may extend between components carried within base 12″ and monitor 16″ or other components associated therewith.

As shown, gaming terminal 10″ includes two different types of input elements 18: touch-sensitive regions 18a of a screen 17 of monitor 16 and buttons 18b associated with the housing of monitor 16. Of course, input elements 18 communicate with processor 14, as known in the art, to effect a desired input thereto, whether it be in response to a game being played, to initiate game play, to terminate game play, or otherwise, as known in the art.

With continued reference to FIGS. 5 and 6 and returning reference to FIGS. 1-4, the movement of monitor 16, 16″ relative to base 12, 12′, 12″ may be effected by either manual, mechanical, or automatic manipulation of support member 20, articulation system 20′, or monitor 16″. A monitor 16, 16″ that may be manually articulated is forced into a desired position by use of a gamer's or other individual's hands to move monitor 16, 16″ and, consequently, in the case of monitor 16, a support member 20 or articulation system 20′ associated therewith.

Mechanical means for articulating monitor 16 and manipulating a support member 20 or articulation system 20′ may include rotating knobs, ratcheting levers or knobs, or other mechanical motion control components that will facilitate the manipulation of support member 20 or articulation system 20′ as desired and, thus, the movement of monitor 16 into a desired position.

Gaming terminal 10″ may similarly include mechanical means for articulating monitor 16″. In automatic systems for manipulating a support member 20 or articulation system 20′ or moving a support arm 22″ and, thus, articulating monitor 16, 16″, movement may be effected by way of motors 30 (e.g., stepper motors, screw-drive motors, etc.) associated with support member 20, articulation system 20′, or support arm 22″. The operation of such motors 30 may be controlled by a individual's use of motion control elements 32, such as buttons, switches, joysticks, or other appropriate devices, that are associated with an actuate one or more corresponding motors 30 in a manner that is well within the skill of one in the art. As yet another alternative, initial movement of monitor 16, 16″ to a desirable position may be completely automated, by use of sensors 34 (e.g., infrared (IR) position or movement sensors or ultrasonic position or movement sensors) aimed to detect the location of a gamer's head and communicate signals that convey information about the same to an articulation controller 36 which, in turn, causes one or more motors 30 to place monitor 16, 16″ into an appropriate position. An individual may then further adjust the position of monitor 16, 16 ″ by use of motion control elements 32.

As another option, processor 14 may detect the particular position in which a monitor 16, 16″ has been positioned by a gamer and, upon receiving instructions from the gamer, such as by use of an input element 18 of gaming terminal 10, 10′, 10″, store such position on storage media of an account card (e.g., a magnetic strip of an account card, memory of a “smart card”, etc.) or in memory associated with processor 14 in conjunction with an identifier for the gamer (e.g., an account number). When the gamer subsequently uses the account card or accesses his or her account at the same or different gaming terminal 10, 10′, 10″, the stored data regarding the position of monitor 16, 16 ″ may be accessed by processor 14 from the card or memory associated with processor 14, as known in the art, and processor 14 may cause any motors in communication therewith to automatically effect movement of monitor 16, 16″ to the stored position.

With continued reference to FIGS. 1-6, base 12, 12′, 12″ and monitor 16, 16″ may be configured in such a way as to impart a gaming terminal 10, 10′, 10″ of which they are a part with a reduced size relative to that of conventional gaming terminals. By way of example only, a gaming terminal incorporating teachings of the present invention (e.g., gaming terminal 10 or 10′) may have a height of about 22 inches and a depth of about nine inches. Gaming terminals 10, 10′ of such small size may be manufactured by omitting the typically bulky equipment that is typically associated with receiving, retaining, and awarding coins, tokens, or currency. Accordingly, such gaming terminals may be referred to as “cashless” gaming terminals.

A gaming terminal 10, 10′ having such a small size may be supported upon a table or other support structure 40, as depicted in FIGS. 1 and 2, or secured to a wall 40′ or other structure, as shown in FIGS. 3 and 4. In either configuration, a gamer's knees and legs may fit at least partially beneath gaming terminal 10, 10′ as the gamer sits on a chair or stool positioned in front of gaming terminal 10, 10′ to use the same. Thus, a gamer may position herself or himself in such a way relative to gaming terminal 10, 10′ that monitor 16 thereof, as well as any input elements 18 associated therewith, are positioned more closely to the gamer. As a result, when a gamer is situated at gaming terminal 10, 10′ with his or her knees at least partially thereunder, the gamer may sit in a more comfortable position (i.e., upright or even somewhat reclined) than the somewhat slumped-over positioned that is required when many previously-existing upright or sit-down (e.g., tabletop, bar-top, etc.) gaming terminals are used.

A gaming terminal (e.g., gaming terminal 10, 10′, 10″) incorporating teachings of the present invention may comprise a stand-alone device or be networked, as known in the art, with one or more other devices, including, without limitation, other gaming terminals, automated cashiers, and the like. In order to facilitate game play at a cashless gaming terminal, such a gaming terminal may be networked with a computer or other device from which user account information, such as the available amount of credit on a credit card account or the balance of a bank account or house account, may be accessed. Alternatively, a networked or unnetworked cashless gaming terminal may be equipped to receive a so-called “smart card”.

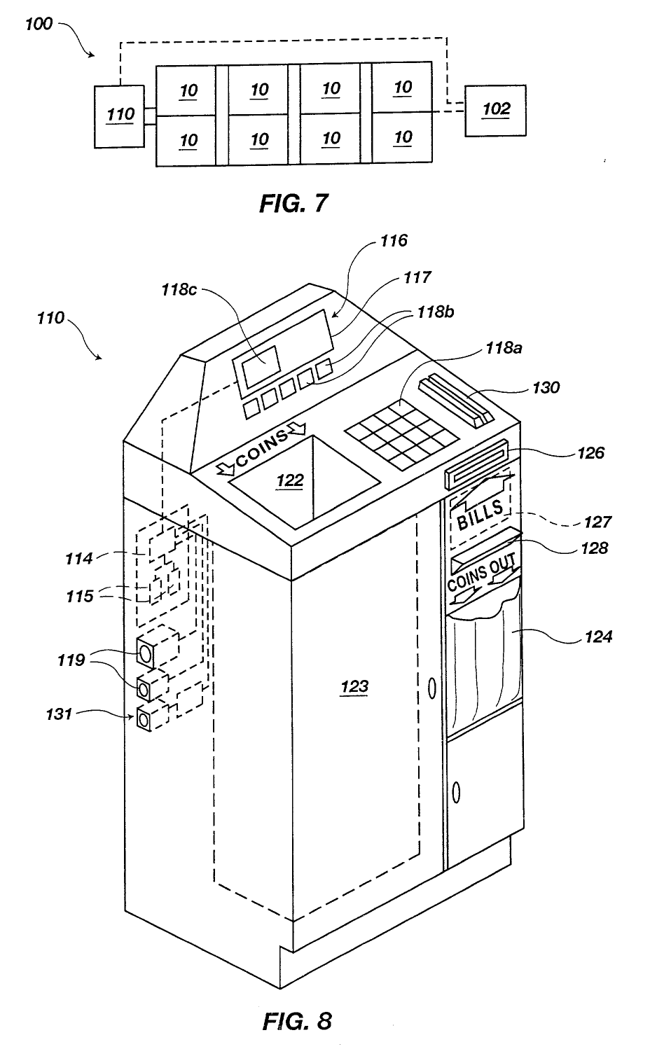

An example of a network 100 that includes a plurality of gaming terminals 10 and an automated cashier 110 associated with gaming terminals 10 is depicted in FIG. 7. Gaming terminals 10 of network 100 may communicate directly with one another, or with an optional network server 102. In either event, each gaming terminal 10 may include a communication component 19 (FIG. 2), such as a modem, communication port, or network card, in communication with processor 14 thereof.

Network 100 may also include at least one automated cashier 110 in either direct or indirect (e.g., through network server 102) communication with each gaming terminal 10 thereof. As depicted in FIG. 8, each automated cashier 110 includes a processor 114, as well as a display device 116 and at least one communication component 119 that are in communication with processor 114. Each automated cashier 110 may also include an input element 118, such as the depicted numeric keypad 118a, buttons 118b, and touch-sensitive regions 118c of screen 117 of display device 116, to facilitate the entry of various types of information, such as account numbers, other account-selection information, personal identification numbers (PINs), monetary amounts, and the like, into processor 114.

In addition, each automated cashier 110 may include one or more of a coin acceptor 122, a bill acceptor 126, and an account card reader 130. Coin acceptor 122 and bill acceptor 126 each communicate with processor 114 and are each configured, as known in the art, to communicate information about the amount of money introduced therein to processor 114. Of course, coin acceptor 122 and bill acceptor 126 have respective coin and bill receptacles 123, 127 associated therewith. A coin receptacle 123 of automated cashier may communicate with a coin dispenser 124, as known in the art, while a bill receptacle 127 may communicate with a bill dispenser 128, such as those commonly used in automatic teller machines (ATMs). An account card reader 130 may be configured to directly (e.g., by a telephone, cable, or other broadband communication line) or indirectly (e.g., through a modem 131 of automated cashier 110 or through network server 102) access a gamer's account that corresponds to a card used therewith and any additional information (e.g., account type, account number, PIN, etc.) that may be required of a gamer before the gamer will be granted access to that particular account.

Processor 114 of each automated cashier 110 of network 100 may be programmed (e.g., by software maintained on storage media that communicates with processor 114, firmware associated with processor 114, or hardware programming of processor 114 itself) to determine a number of credits to be added to a gamer's account and to add the appropriate number of credits to that gamer's account.

In a first example of the use of automated cashier 110, a gamer may open a house account by use of an input element 118, such as numeric keypad 118a or touch-sensitive region 118c of display 116 screen 117, to enter certain personal or identifying information, such as a room number, a name, and/or a PIN. Processor 114 may cause memory 115 associated with processor 114 to store such information or communicate such information through a communication component 119 of automated cashier 110 to network server 102 for storage thereby. The gamer may then create a house account balance by inserting coins or bills into their respective acceptors 122, 126.

Alternatively, a gamer may create a house account balance by causing automated cashier 110 to electronically access a financial account of the gamer's. This may be done by requiring the gamer to at least partially insert an account card into, or to “swipe” or “run” the account card through, card reader 130 of automated cashier 110 and, optionally, requiring the gamer to select a particular account from which a specified monetary amount is to be deducted. The gamer may also be required to enter additional information associated with a particular account card or selected account, such as a PIN, into processor 114 by use of an input element 118 associated therewith. Once the necessary information has been provided to processor 114, processor 114 communicates with a computer (not shown) of the appropriate financial institution (i.e., that at which the gamer's specified account is held), as known in the art, to cause the specified amount to be deducted from the appropriate, specified account.

Other known methods for electronically transferring currency may also be used at an automated cashier 110 that incorporates teachings of the present invention to add money to a gamer's house account.

Once money has been introduced into automated cashier 110 or an electronic financial transfer has been approved and effected, processor 114 of automated cashier 110 then causes the appropriate monetary amount or an equivalent number of gaming credits to be added to the gamer's house account. The gamer may be provided with one or more of a house account number, a house account card, and a PIN (randomly generated or entered by the gamer) to subsequently access his or her house account.

In a second example of the use of automated cashier 110, a house account balance may be increased in the same manner as described above for setting up a house account. Of course, the gamer must access his or her house account prior to increasing the balance of that account. For example, if a house account card has been provided to the gamer, the gamer may be required to insert or swipe that card through card reader 130 to access his or her house account. Alternatively, the gamer may be required to enter an account number or other identifier into an input element 118, such as numeric keypad 118a, of automated cashier before being provided access to his or her house account. Entry of a PIN may also be required. The balance of the selected account may then be increased, as described above, by inserting money into coin acceptor 122 or bill acceptor 126 or by accessing another account of the gamer's.

When a gamer selects a gaming terminal 10 for use, the gamer may stand or sit down in front of monitor 16 thereof and position monitor 16 in a desired location, which, of course, requires manual, mechanical, or automatic manipulation of the support member 20 (FIGS. 1 and 2) or articulation system 20′ (FIGS. 3 and 4) associated therewith.

With returned reference to FIGS. 1-6, since monitor 16, 16′ is in a desired location and the gamer has situated himself or herself as desired, game play may be initiated at a gaming terminal 10 of network 100 (FIG. 7) by providing processor 14 with an appropriate house account identifier (e.g., account number, PIN, or other identifying information) by entering the same into a keypad 18c or other user input element 18 and/or by inserting a house account or other account card at least partially into a card reader 15 of gaming terminal 10. Programming of processor 14 may then cause processor 14 to access the appropriate house account or other account, such as by establishing communication with network server 102 or another external computer on which appropriate account information is stored. Once the appropriate account has been accessed by processor 14, a monetary amount, as indicated by the gamer, may be deducted therefrom and credited to processor 14 or memory associated therewith, in the form of gaming credits. Access by processor 14 to the gamer's account may then be maintained or terminated. Of course, automatic termination of such access provides the gamer with greater security than would requiring the gamer to terminate account access. The gamer may then initiate play of a selected game by wagering a specified number of credits on the selected game, as known in the art.

Any game credit or monetary losses incurred by the gamer result in processor 14 of gaming terminal 10 causing monetary credit to be added to an account of the owner of gaming terminal 10 or to another specified party, as known in the art.

In the event that all of the gamer's credits are used up, processor 14 may again access an account that has been specified by the gamer. While a previously accessed account may be automatically reaccessed, it is preferred, for the gamer's own security, that the gamer again be required to enter any necessary account information prior to processor 14 establishing access to a desired account.

If the gamer has any credits remaining when he or she is done playing the selected game at a particular gaming terminal 10, the gamer may indicate to processor 14 that gaming is complete by use of an input element associated with processor 14. Processor 14 may then automatically reaccess the last-accessed account or require the gamer to provide the necessary information before processor 14 will access the desired account. Processor 14 may then cause the remaining number of gaming credits to be added to the balance of the accessed account.

Referring again to FIG. 8, a third example of the manner in which automated cashier 110 may be used includes a gamer's removal of a monetary amount from his or her house account. Again, the gamer accesses the desired house account using the appropriate house account card, account number or other identifier, and/or PIN. The gamer may then select and indicate to processor 114 of automated cashier 110 the desired manner in which gaming credits are to be received (e.g., transferred an account of the gamer's or “cashed-in”). Such a selection may be made by use of an input element 118 of automated cashier 110, such as by depressing an appropriate button 118b thereof. A desired amount of money to be removed from the house account may also be entered into numeric keypad 118a by the gamer and communicated to processor 114. Of course, it is preferred that processor 114 not permit the gamer to deduct an amount from the house account that exceeds the balance of the house account.

If the gamer indicated to processor 114 that the deduction occur in the form of money, processor 114 may cause coin dispenser 124 and/or bill dispenser 128 to provide the gamer with the desired amount of money. Alternatively, if it is desired that a monetary amount be electronically transferred and added to another account of the gamer's, processor 114 may instruct the gamer, by way of display 116, to enter the appropriate account information, either by use of a user input element 118 and/or card reader 130. The appropriate account may then be accessed, as known in the art and described above, and the desired amount electronically transferred thereto, also as known in the art and described above.

Although the foregoing description contains many specifics, these should not be construed as limiting the scope of the present invention, but merely as providing illustrations of some exemplary embodiments. Similarly, other embodiments of the invention may be devised which do not part from the spirit or scope of the present invention. Features from different embodiments may be employed in combination. The scope of the invention is, therefore, indicated and limited only by the appended claims and their legal equivalents, rather than by the foregoing description. All additions, deletions, and modifications to the invention, as disclosed herein, which fall within the meaning and scope of the claims are to be embraced thereby.

What is claimed:

1. A gaming terminal, comprising:
a body;
at least one processor within said body;
at least one monitor in communication with said at least one processor and secured to said body so as to be adjustable to a plurality of orientations; and
at least one input element in communication with said at least one processor.

2. The gaming terminal of claim 1, wherein said at least one monitor comprises a flat panel display.

3. The gaming terminal of claim 2, wherein said at least one flat panel display comprises a flat cathode ray tube display.

4. The gaming terminal of claim 2, wherein said at least one flat panel display comprises a field emission array.

5. The gaming terminal of claim 2, wherein said at least one flat panel display comprises a light emitting diode display.

6. The gaming terminal of claim 1, wherein said at least one input element comprises at least one touch sensitive region of a screen of said at least one monitor.

7. The gaming terminal of claim 1, wherein said at least one input element is separate from a screen of said at least one monitor.

8. The gaming terminal of claim 1, wherein said at least one processor is in communication with one or more devices external to the gaming terminal.

9. The gaming terminal of claim 1, wherein said at least one processor does not require the introduction of currency into an apparatus at least partially contained within said housing prior to initiating a game.

10. The gaming terminal of claim 1, further comprising:
a support for securing said at least one monitor to said body.

11. The gaming terminal of claim 10, wherein said support is configured to facilitate movement of said at least one monitor along at least one axis.

12. The gaming terminal of claim 10, wherein said support is configured to facilitate movement of said at least one monitor along a plurality of axes.

13. The gaming terminal of claim 10, wherein said support is configured to facilitate at least horizontal movement of said at least one monitor.

14. The gaming terminal of claim 10, wherein said support is configured to facilitate at least vertical movement of said at least one monitor.

15. The gaming terminal of claim 10, wherein said support is configured to facilitate at least pivotal movement of said at least one monitor.

16. A cash-free gaming terminal, consisting essentially of:
at least one processor;
at least one monitor in communication with said at least one processor and moveable to a plurality of orientations;
at least one input element in communication with said at least one processor.

17. The cash-free gaming terminal of claim 16, wherein said at least one monitor comprises a flat panel display.

18. The cash-free gaming terminal of claim 17, wherein said at least one monitor comprises a flat cathode ray tube display.

19. The cash-free gaming terminal of claim 17, wherein said at least one monitor comprises a field emission array.

20. The cash-free gaming terminal of claim 17, wherein said at least one monitor comprises a light emitting diode display.

21. The cash-free gaming terminal of claim 16, wherein said at least one input element comprises at least one touch sensitive region of a screen of said at least one monitor.

22. The cash-free gaming terminal of claim 16, wherein said at least one input element is separate from a screen of said at least one monitor.

23. The cash-free gaming terminal of claim 16, wherein said at least one processor is in communication with one or more devices external to the cash-free gaming terminal.

24. The cash-free gaming terminal of claim 23, wherein said at least one processor is in communication with a processor of an automated cashier.

25. The cash-free gaming terminal of claim 16, further comprising:
an articulation system for said at least one monitor.

26. The cash-free gaming terminal of claim 25, wherein said articulation system is configured to facilitate movement of said at least one monitor along at least one axis.

27. The cash-free gaming terminal of claim 25, wherein said articulation system is configured to facilitate movement of said at least one monitor along a plurality of axes.

28. The cash-free gaming terminal of claim 25, wherein said articulation system is configured to facilitate at least horizontal movement of said at least one monitor.

29. The cash-free gaming terminal of claim 25, wherein said articulation system is configured to facilitate at least vertical movement of said at least one monitor.

30. The cash-free gaming terminal of claim 25, wherein said articulation system is configured to facilitate at least pivotal movement of said at least one monitor.

31. A gaming system, comprising:
at least one automated cashier; and
a plurality of cashless gaming terminals, each gaming terminal of said plurality including:
a processor that communicates with a processor of said at least one automated cashier; and;
an articulating monitor in communication with said processor of said gaming terminal.

32. The gaming system of claim 31, wherein said at least one automated cashier is located in proximity to at least one gaming terminal of said plurality of gaming terminals.

33. The gaming system of claim 32, wherein said at least one automated cashier and said at least one gaming terminal are positioned adjacent to one another.

34. The gaming system of claim 32, wherein said at least one automated cashier and said plurality of gaming terminals are physically grouped together.

35. The gaming system of claim 31, wherein said at least one automated cashier comprises:
said processor;
a housing;
at least one of a receptacle for currency and a card reader at least partially contained within said housing and in communication with said processor;
a currency dispenser at least partially contained within said housing and in communication with said processor; and
a display at least partially contained within said housing and in communication with said processor.

36. The gaming system of claim 35, further comprising: an input element at least partially contained within said housing and in communication with said processor.

37. The gaming system of claim 36, wherein said input element comprises at least a touch sensitive region of a screen of said display.

38. The gaming system of claim 36, wherein said input element is separate from a screen of said display.

39. The gaming system of claim 31, wherein said articulating monitor comprises a flat panel display.

40. The gaming system of claim 39, wherein said flat panel display comprises a flat cathode ray tube display.

41. The gaming system of claim 39, wherein said flat panel display comprises a field emission array.

42. The gaming system of claim 39, wherein said flat panel display comprises a light emitting diode display.

43. The gaming system of claim 31, wherein each gaming terminal further comprises: a support member for facilitating movement and positioning of said articulating monitor.

44. The gaming system of claim 43, wherein said support member is configured to facilitate movement of said articulating monitor along at least one axis.

45. The gaming system of claim 43, wherein said support member is configured to facilitate movement of said articulating monitor along a plurality of axes.

46. The gaming system of claim 43, wherein said support member is configured to facilitate at least horizontal movement of said articulating monitor.

47. The gaming system of claim 46, wherein said support member is configured to facilitate at least vertical movement of said articulating monitor.

48. The gaming system of claim 46, wherein said support member is configured to facilitate at least pivotal movement of said articulating monitor.

49. A gaming method, comprising:
selecting a gaming terminal at which a game is to be played;
situating a gamer in a desired position at said gaming terminal; and
adjusting at least one element of said gaming terminal to facilitate access thereto by said gamer while in said desired position.

50. The gaming method of claim 49, wherein said adjusting at least one element comprises placing a monitor of said gaming terminal in a desired location.

51. The gaming method of claim 49, wherein said adjusting is at least partially manually effected.

52. The gaming method of claim 49, wherein said adjusting is at least partially automatically effected.

53. The gaming method of claim 49, further comprising:
initiating a game at said gaming terminal.

54. The gaming method of claim 53, further comprising:
obtaining at least one game credit at a location remote from said gaming terminal, said initiating said game comprising use of said at least one game credit.

55. The gaming method of claim 54, wherein said obtaining at least one game credit includes obtaining a house account to be used at least at said remote location.

56. The gaming method of claim 55, wherein said obtaining said house account comprises obtaining at least one of an account card and an account number.

57. The gaming method of claim 55, further comprising:
using said house account at least at said remote location.

58. The gaming method of claim 57, wherein said using said house account comprises entering at least one of an account number into a user input element of said gaming terminal at said remote location and at least partially inserting an account card into a card reader of said gaming terminal.

59. The gaming method of claim 57, further comprising:
selecting a number of game credits to be used to play a game at said gaming terminal at said remote location.

60. The gaming method of claim 59, wherein said selecting comprises wagering said number of game credits on said game.

61. The gaming method of claim 54, further comprising:
receiving monetary compensation for credits at a location remote from said gaming terminal.
